(19) United States
(12) Patent Application Publication
(10) Pub. No.: US 2019/0185307 A1
(43) Pub. Date: Jun. 20, 2019

(54) VACUUM RELEASE APPARATUS

(71) Applicant: Michael E. Stude, Lake Forest, CA (US)

(72) Inventor: Michael E. Stude, Lake Forest, CA (US)

(21) Appl. No.: 15/844,297

(22) Filed: Dec. 15, 2017

(51) Int. Cl. B67B 7/20

(52) U.S. Cl. CPC B67B 7/20; B67B 7/24

(57) ABSTRACT

A vacuum release apparatus includes a compressible housing and a puncture component in the housing. The puncture component is configured to move as the housing is compressed.

### BACKGROUND OF THE INVENTION

The present invention generally relates to the release of contents in vacuum sealed containers and, more particularly, to apparatus and methods for equalizing pressure between an ambient pressure and a container pressure to enable contents in the container to be removed.

Vacuum sealed containers are frequently used to store food contents. Often, the containers are made of a metal, such as tin-coated steel or aluminum. When the contents are to be used or consumed, a lid can be removed.

However, the contents in the container are often vacuumed against the opposite lid. Thus, the contents will not easily release itself from the container.

The user is then relegated to shaking the container in an upside down orientation, squeezing the sides of the container, spooning out the contents, or the like.

This can lead to frustration and wasted time by the user.

Apparatus used in the past to release contents from a vacuumed container is shown, for example, in U.S. Pat. No. 7,328,731. Pre-loading of a spring to move a piercing device is employed. A trigger pin, trigger block and trigger hole allow the spring to move the piercing device towards the container. The number of components is many and subject to deterioration and failure. There is also difficulty in cleaning.

As can be seen, there is a need for improved apparatus and methods for equalizing pressure between an ambient pressure and a container pressure to enable contents in the container to be removed.

### SUMMARY OF THE INVENTION

In one aspect of the present invention, a vacuum release apparatus comprises a compressible housing; and a puncture component in the housing; wherein the puncture component is configured to move as the housing is compressed.

In another aspect of the present invention, an apparatus for releasing contents from a container comprises a housing configured to move between an activated position and a non-activated position; and a puncture component stationarily fixed in the housing.

In a further aspect of the present invention, an apparatus for equalizing pressure between an ambient pressure and a container pressure consists of a housing; a piercing element having a piercing portion that is configured to move between a piercing position and a non-piercing position; wherein the piercing element is configured to move in the absence of a spring and piston.

These and other features, aspects and advantages of the present invention will become better understood with reference to the following drawings, description and claims.

### BRIEF DESCRIPTION OF THE DRAWINGS

FIG. 1 is a perspective view of a vacuum release apparatus according to an embodiment of the present invention;

FIG. 2 is a perspective view of a housing of a vacuum release apparatus according to an embodiment of the present invention;

FIG. 3 is a side, planar view of a housing of a vacuum release apparatus according to an embodiment of the present invention;

FIG. 4 is a top view of a housing of a vacuum release apparatus according to an embodiment of the present invention;

FIG. 5 is a perspective view of a puncture component of a vacuum release apparatus according to an embodiment of the present invention;

FIG. 6 is a side, planar view of a puncture component of a vacuum release apparatus according to an embodiment of the present invention;

FIG. 7 is a top view of a puncture component of a vacuum release apparatus according to an embodiment of the present invention;

FIG. 8A is a side, planar view of the vacuum release apparatus in a non-activated position according to an embodiment of the present invention;

FIG. 8B is a side, planar view of the vacuum release apparatus in an activated position according to an embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features. However, any single inventive feature may not address any of the problems discussed above or may only address one of the problems discussed above. Further, one or more of the problems discussed above may not be fully addressed by any of the features described below.

Broadly, the present invention provides apparatus and methods for equalizing pressure between an ambient pressure and a container pressure to enable contents in the container to be removed. The present invention provides a vacuum release apparatus that can include a housing and a puncture component.

Generally, in accordance with the present invention, upon an external application of force to the housing, the housing may compress from a non-activated position to an activated position. Concurrently, the puncture component may move from a non-puncture position to a puncture position. In the puncture position, the puncture component may puncture a container having contents therein.

The puncture of the container may enable the pressure inside of the container to equilibrate with the ambient pressure outside of the container. Thereby, contents in the container may be released from an otherwise existent vacuum between the contents and the container surface that was punctured.

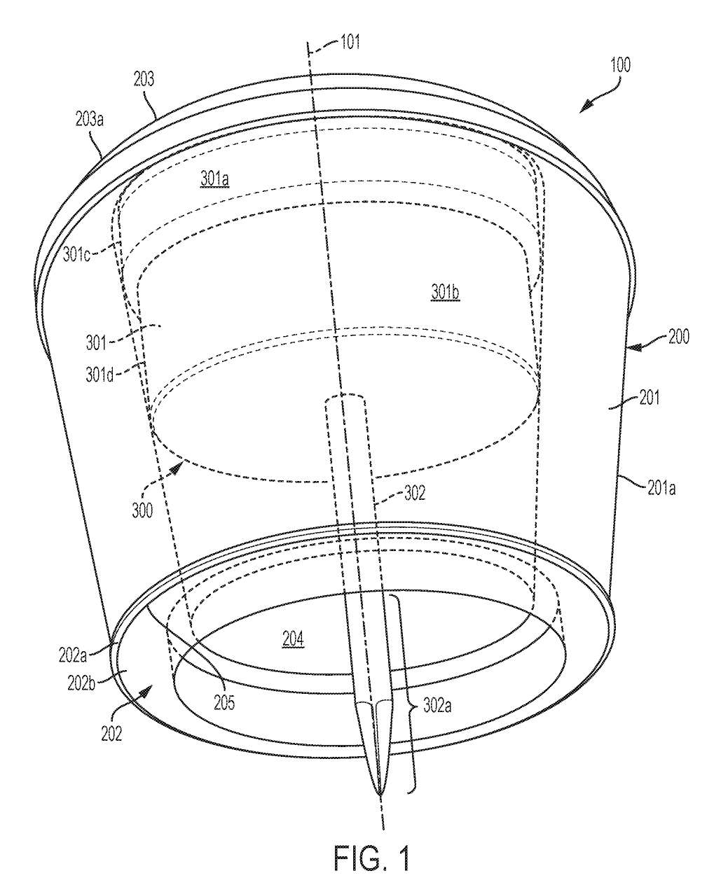

FIG. 1 depicts an exemplary embodiment of a vacuum release apparatus 100 according to the present invention. The apparatus 100 may extend along a longitudinal axis 101. The apparatus 100 may consist of only a housing 200 and a puncture component 300. In other words, the apparatus does not rely on additional components, such as a spring or piston, to operate.

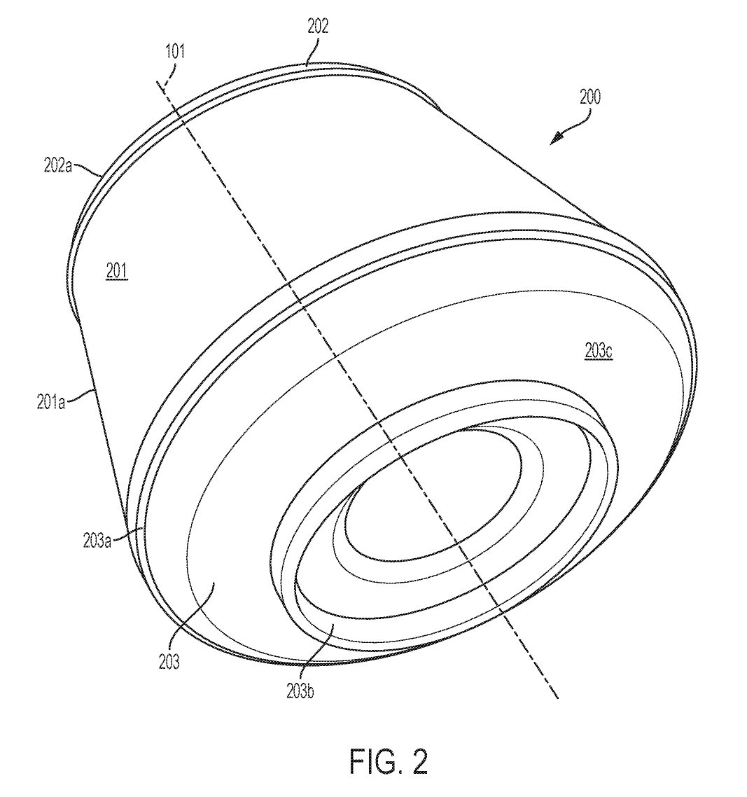

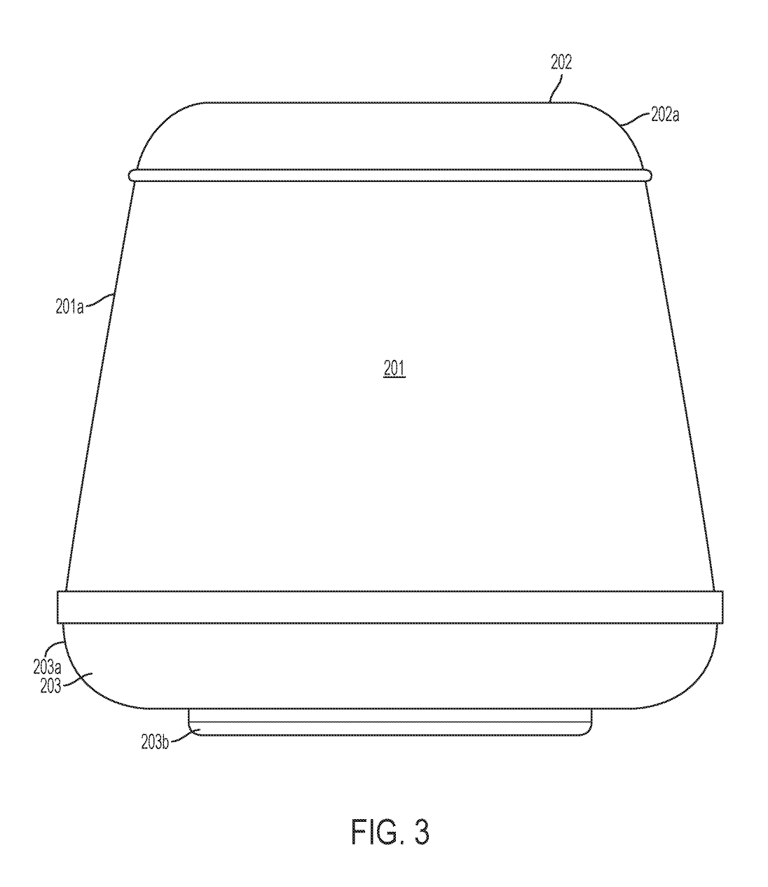

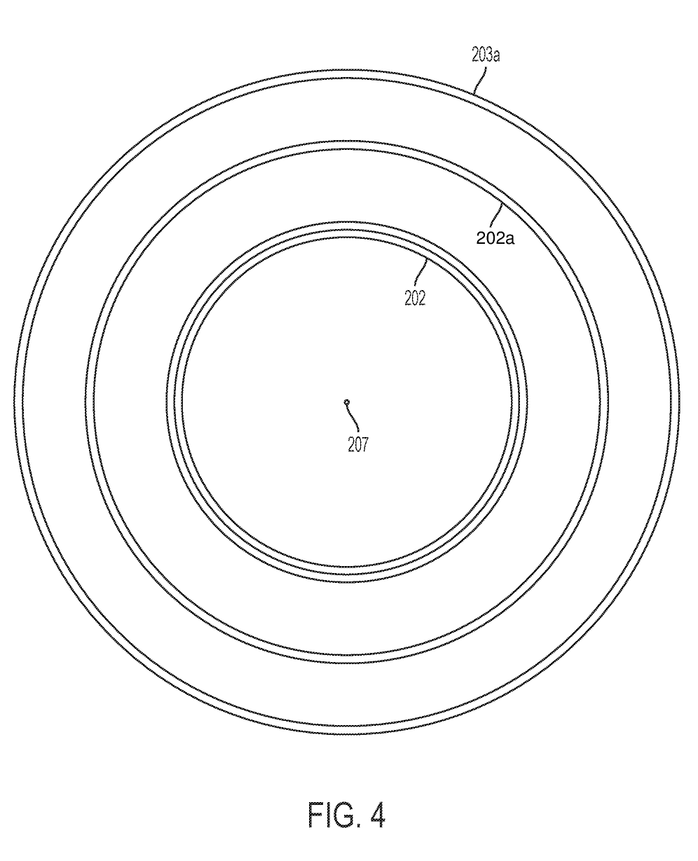

As shown in FIGS. 2-4, in embodiments, the housing 100 may be a one-piece integral component. The housing 100 may have a generally frusto-conical shape having a longitudinal centerline 207 that lies along the longitudinal axis 101. The housing 200 may include, at one end thereof, an interfacing portion 202 with a peripheral edge 202a and a substantially planar surface 202b. The interfacing portion 202 can be configured to interface and contact a surface of a container, as further described below.

The housing 200 may further include, at an opposite end thereof, an impact portion 203 with a peripheral edge 203a and a substantially planar surface 203c. In embodiments, the peripheral edge 203a and the peripheral edge 202a may be defined by respective circumferences. In embodiments, the circumference of the peripheral edge 203a may be larger than the circumference of the peripheral edge 202a.

In embodiments, the impact portion 203 may optionally include an extended component 203b. The extended component 203b may have a ring-like shape.

The housing 200 may additionally include a body portion 201 with a peripheral side 201a. In embodiments, the peripheral side 201a may be angled relative to the longitudinal axis 101a and defined by a changing circumference. In embodiments, the changing circumference may be from about the circumference of the peripheral edge 202a and transition to about the circumference of the peripheral edge 203a.

In embodiments, the housing 200 may be made of a compressive material, such as rubber. In other embodiments, the housing 200 may be made of a flexible material, such as rubber. In further embodiments, the housing 200 may be made of a non-compressive and/or non-flexible material, such as wood.

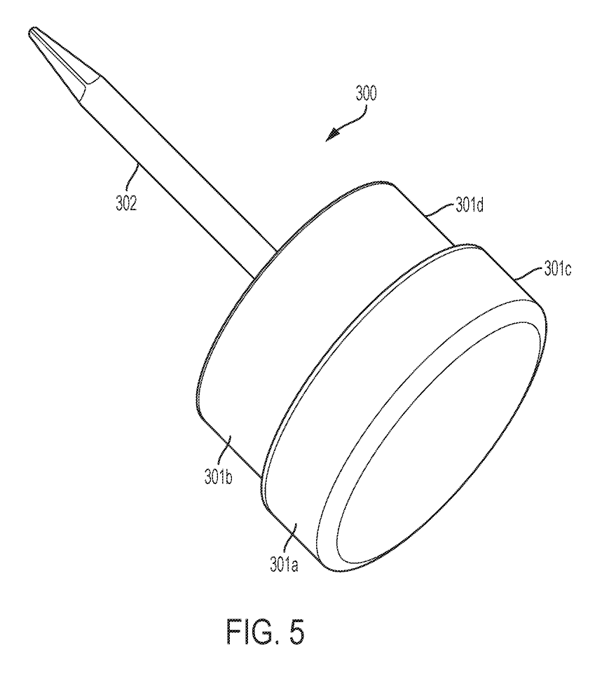

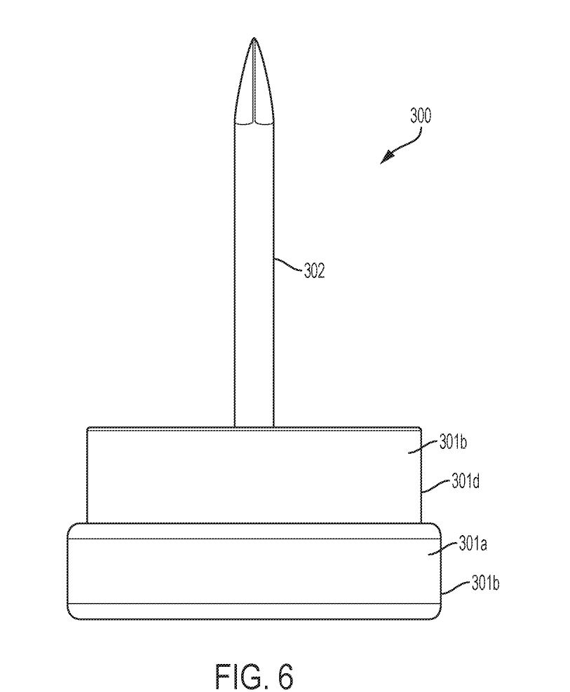

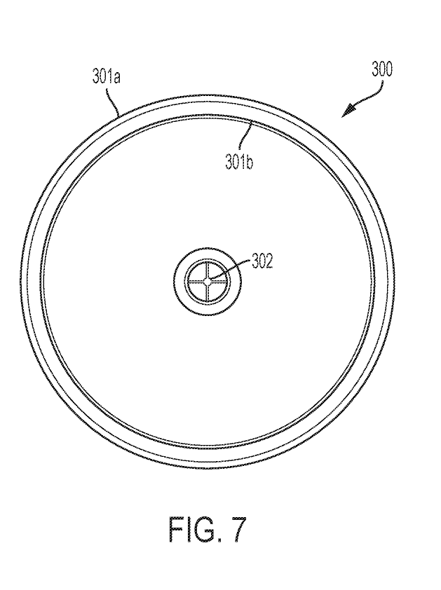

In FIGS. 5-7, the puncture component 300 may be fixed in and substantially stationary relative to the housing 200. That is, the puncture component 300 does not rotate about the longitudinal axis 101 relative to the housing 200, does not rotate within and relative to the housing 200, and does not translate along the longitudinal axis 101 relative to the housing 200.

The puncture component 300 may include a piercing element 302 configured to pierce a surface of a container, such as the lid of a container. Moreover, the piercing element 302 may include a piercing portion 302a (FIG. 1) that extends out of the housing 200 and is configured to puncture a hole in the surface or lid of the container.

The puncture component 300 may further include a first support 301a. In embodiments, the first support 301a may have a disk shape with a peripheral edge 301c. In embodiments, the peripheral edge 301c may be defined by a circumference substantially equal to an interior circumference of the housing 200 near or at the impact portion 203.

The puncture component 300 may additionally include a second support 301b that directly interfaces the first support 301a. In embodiments, the second support 301b may have disk shape with a peripheral edge 301d. In embodiments, the peripheral edge 301d may be defined by a circumference less than the circumference of the peripheral edge 301c.

In embodiments, one or both of the first and second supports 301a, 301b may be made of a compressible and/or flexible material. Thereby, the first and second supports 301a, 301b may be inserted into the housing 200. So inserted, the peripheral edges 301c, 301d may abut the interior surface of the housing 200. Thereby, the peripheral edges may stationarily fix the puncture component 300 in the housing 200 and position the piercing element 302 (particularly, the piercing portion 302a) outside of the housing 200.

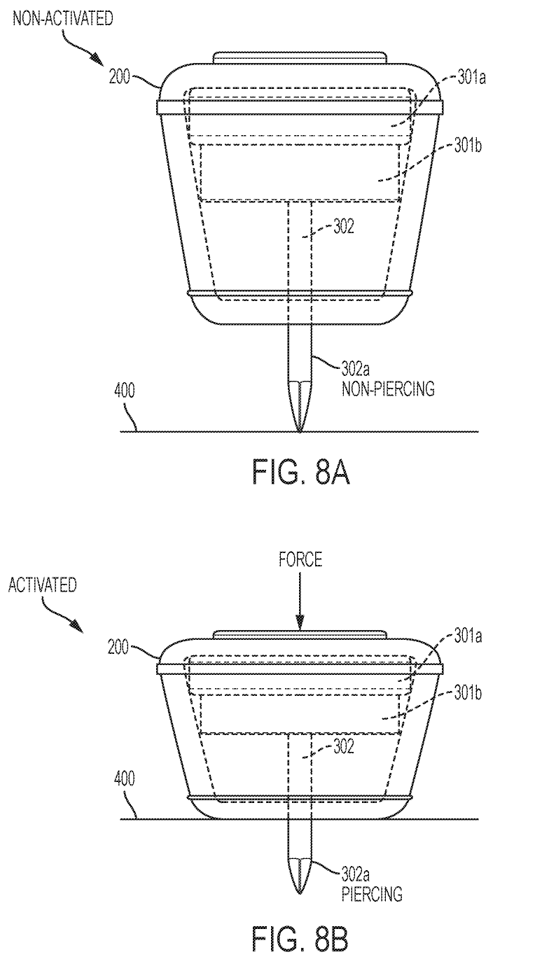

FIGS. 8A-B depict the apparatus 100 in use. In FIG. 8A, the apparatus 100 is shown adjacent to a container surface 400, such as the lid of a container. The housing 200 is in a non-activated position. The puncture component 300 is in a non-puncture position which can include the piercing element 302 (in particular, the piercing portion 302a) in contact with the surface 400. As seen in FIG. 8A, when the housing 200 in the non-activated position, the piercing portion 302a extends outside of the housing 200.

In FIG. 8B, an external application of force to the apparatus 100 may be applied. In embodiments, the applied force may be parallel to and/or along the longitudinal axis 101. In embodiments, the applied force may be from a user's hand and/or an instrument such as a mallet.

The applied force may then cause the housing 200 to compress and/or flex. In embodiments, the housing 200 may be configured to compress parallel to and/or along the longitudinal axis. The housing may be further configured to enable the compression to move the housing 200 towards the surface 400, and from the non-activated position to an activated position. Accordingly, such movement is accomplished in the absence of an additional component, such as a spring or piston.

Concurrently, the compression of the housing 200 may move the puncture component 300 towards the surface 400. Moreover, the housing 200 may be configured to move the puncture component 300 (in particular, the piercing component 302) from the non-piercing position to a piercing position, in the absence of an additional component, such as a spring or piston. In the piercing position, the piercing portion 302a (which is outside of the housing 200) has pierced the surface 400. A resulting hole in the surface 400 allows ambient pressure to equilibrate with interior pressure of the container. Consequently, contents previously vacuumed to the surface 400 are readily released from the surface 400.

It should be understood, of course, that the foregoing relates to exemplary embodiments of the invention and that modifications may be made without departing from the spirit and scope of the invention as set forth in the following claims.

We claim:

1. A vacuum release apparatus, comprising:
a compressible housing; and
a puncture component in the housing;
wherein the puncture component is configured to move as the housing is compressed.

2. The apparatus of claim 1, wherein the housing is made of a compressible material.

3. The apparatus of claim 1, wherein the housing is made of a flexible material.

4. The apparatus of claim 1, wherein the housing includes an interfacing portion that is configured to interface and contact a container.

5. The apparatus of claim 1, wherein the puncture component is stationarily fixed in the housing.

6. The apparatus of claim 1, wherein the puncture component includes a piercing element configured to puncture a hole in a container.

7. An apparatus for releasing contents from a container, comprising:
a housing configured to move between an activated position and a non-activated position; and
a puncture component stationarily fixed in the housing.

8. The apparatus of claim 7, wherein the housing is configured to move in the absence of an additional component of the apparatus.

9. The apparatus of claim 7, wherein the housing is configured to compress in a direction along a longitudinal axis of the housing.

10. The apparatus of claim 7, wherein the housing is configured to move along a longitudinal axis of the housing when a force is applied to the housing along the longitudinal axis.

11. The apparatus of claim 7, wherein the puncture component is configured to move between a puncture position and a non-puncture position in the absence of a spring.

12. The apparatus of claim 7, wherein the puncture component extends out of the housing.

13. The apparatus of claim 7, wherein the puncture component includes a piercing element configured to pierce the container.

14. An apparatus for equalizing pressure between an ambient pressure and a container pressure, consisting of:
a housing;
a piercing element having a piercing portion that is configured to move between a piercing position and a non-piercing position;
wherein the piercing element is configured to move in the absence of an additional component of the apparatus.

15. The apparatus of claim 14, wherein the housing compresses, upon an external application of force to the apparatus, along a longitudinal axis of the apparatus.

16. The apparatus of claim 14, wherein the housing is configured to move, along a longitudinal axis of the apparatus, between an activated position and a non-activated position.

17. The apparatus of claim 14, wherein the piercing element moves, upon an external application of force to the apparatus, along a longitudinal axis of the apparatus.

18. The apparatus of claim 14, wherein the piercing portion is configured to pierce a container upon movement of the housing.

19. The apparatus of claim 14, wherein the piercing component is stationarily fixed in the housing.
